(19) United States
(12) Patent Application Publication
(10) Pub. No.: US 2019/0238736 A1
(43) Pub. Date: Aug. 1, 2019

(54) ACTUATOR AND CAMERA DEVICE

(71) Applicant: PANASONIC INTELLECTUAL PROPERTY MANAGEMENT CO., LTD, Osaka (JP)

(72) Inventors: Hidetaka MORIMITSU, Osaka (JP); Masaaki OCHI, Osaka (JP)

(21) Appl. No.: 16/375,669

(22) Filed: Apr. 4, 2019

Related U.S. Application Data
(63) Continuation of application No. PCT/JP2017/034909, filed on Sep. 27, 2017.

(30) Foreign Application Priority Data
Oct. 5, 2016 (JP) 2016-197416

(51) Int. Cl. H04N 5/232; G03B 17/56; F16M 11/18; F16M 11/10; F16M 11/12; G10L 15/22; H04N 5/225

(52) U.S. Cl. CPC H04N 5/232; G03B 17/561; F16M 11/18; F16M 11/105; G10L 2015/223; F16M 11/128; G10L 15/22; H04N 5/2253; F16M 2200/00; F16M 11/125

(57) ABSTRACT

An actuator includes: a member for holding an object thereon; a fixed member; a drive: and a controller. The fixed unit holds the member to allow the member to rotate in at least two directions including a rolling direction and a panning direction or a tilting direction. The drive drives the member in rotation in the at least two directions with respect to the fixed member. The controller drives the member in vibration at a frequency of an audible sound in at least one direction out of the at least two directions. The member includes: a holder for holding the object thereon; and a body for supporting the holder. The holder includes a columnar portion protruding in an axial direction that defines a center of the rolling direction and serving as a rotor to rotate around the axial direction.

### TECHNICAL FIELD

The present disclosure relates to an actuator and a camera device, and more particularly relates to an actuator and camera device configured to drive an object to be driven in rotation.

### BACKGROUND ART

A camera driver has been known which is able to rotate the barrel of a camera in at least two of a tilting direction, a panning direction, and a rolling direction. For example, WO 2010/010712 A1 (hereinafter referred to as D1) discloses a camera driver with a camera unit rotatable in three directions. In D1, the camera unit includes a lens and a lens barrel for holding the lens. The lens and the lens barrel have a circular cross section perpendicularly to the optical axis of the camera unit. As used herein, the “tilting direction” refers to a rotational direction defined around one of two orthogonal axes that are perpendicular to the optical axis of the camera unit. The “panning direction” refers herein to a rotational direction defined around the other axis. The rolling direction refers herein to a rotational direction defined around the optical axis of the camera unit.

The drivability of such a camera driver (actuator) for rotating a movable unit in at least two of the tilting, panning, and rolling directions sometimes cannot be checked by eye. For example, in checking the rotation in the rolling direction of the camera driver of D1, it is difficult to determine whether the camera driver is rotating in the rolling direction because the lens and lens barrel thereof have a circular cross section perpendicularly to the optical axis of the camera unit.

### SUMMARY

The present disclosure provides an actuator and camera device allowing the drivability to be checked by a different method, other than eye inspection, in at least one of the rotatable directions.

An actuator according to an aspect of the present disclosure includes: a member for holding an object to be driven thereon; a fixed member; a drive: and a controller. The fixed member holds the member so as to allow the member to rotate in at least two directions including a rolling direction and a direction selected from the group consisting of a panning direction and a tilting direction. The drive drives the member in rotation in the at least two directions with respect to the fixed member. The controller outputs, to the drive, a drive signal for driving the member in rotation. The controller drives the member in vibration at a frequency of an audible sound in at least one direction out of the at least two directions. The member includes a holder and a body. The holder holds the object to be driven thereon. The body supports the holder. The holder includes a columnar portion. The columnar portion protrudes in an axial direction that defines a center of the rolling direction and serves as a rotor to rotate around the axial direction.

A camera device according to another aspect of the present disclosure includes the actuator described above, and a camera module serving as the object to be driven.

### BRIEF DESCRIPTION OF DRAWINGS

FIG. 1 is a block diagram illustrating a configuration for an actuator according to an embodiment of the present disclosure;

FIG. 2A is a perspective view of a camera device according to an embodiment of the present disclosure;

FIG. 2B is a cross-sectional view, taken along the plane X-X (Y-Y), of the camera driver;

FIG. 3 is an exploded perspective view of the camera device;

FIG. 4 is an exploded perspective view of a movable unit included in the actuator;

FIG. 5 is a cross-sectional view of the camera device in a state where the movable base is interposed between a body of a fixed unit, on which a printed circuit board has been mounted, and a coupling member;

FIG. 6 is a flowchart showing the procedure of operation check processing to be performed when a camera device including the actuator is started; and

FIG. 7 is a perspective view illustrating a variation of the actuator.

### DESCRIPTION OF EMBODIMENTS

Note that embodiments and their variations to be described below are only examples of the present disclosure and should not be construed as limiting. Rather, those embodiments and variations may be readily modified in various manners depending on a design choice or any other factor without departing from a true spirit and scope of the present disclosure.

### First Embodiment

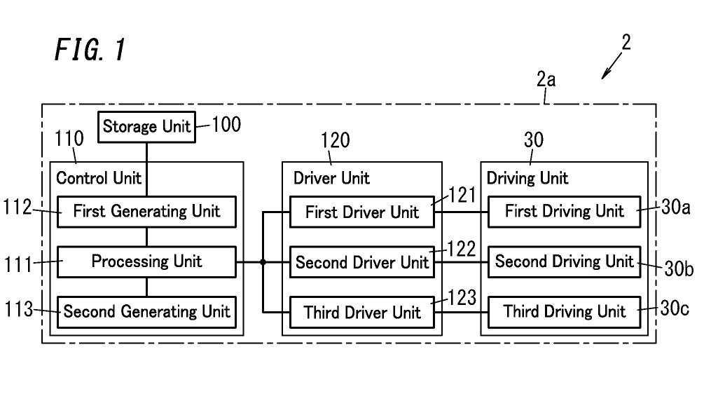

A camera device 1 according to this embodiment will be described with reference to FIGS. 1-6.

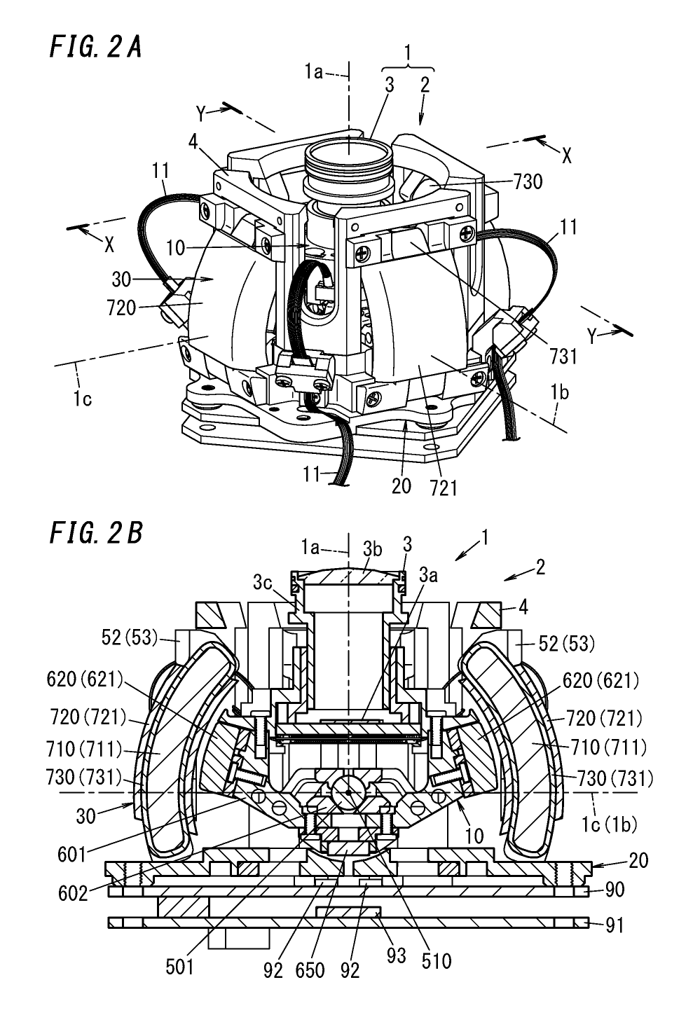

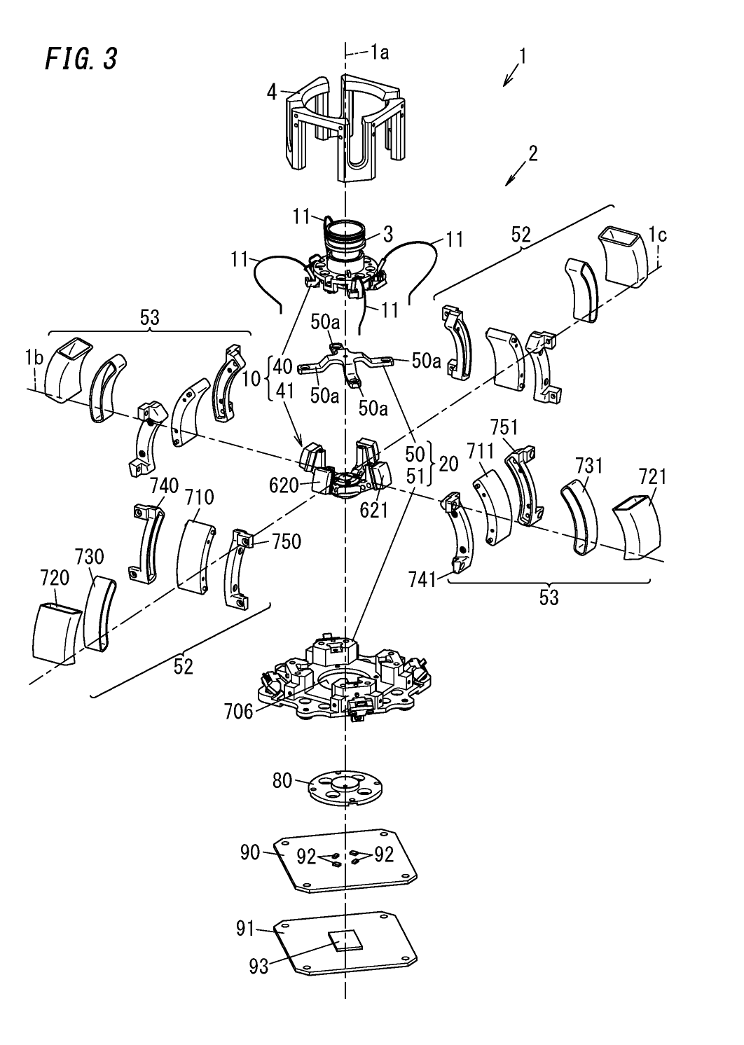

The camera device 1 may be a portable camera, for example, and includes an actuator 2 and a camera module 3 as shown in FIGS. 2A-3. The camera module 3 is rotatable in a tilting direction, a panning direction, and a rolling direction. The actuator 2 serves as a stabilizer 2a for reducing unnecessary vibrations of the camera module 3 by driving the camera module 3 in a predetermined rotational direction.

The camera module 3 includes an image capture device 3a, a lens 3b to form a subject image on an image capturing plane of the image capture device 3a, and a lens barrel 3c to hold the lens 3b. The camera module 3 converts video produced on the image capturing plane of the image capture device 3a into an electrical signal. The lens barrel 3c protrudes in the direction in which the optical axis 1a of the camera module 3 extends. The lens barrel 3c has a circular cross section perpendicularly to the optical axis 1a. Also, a plurality of cables to transmit the electrical signal generated by the image capture device 3a to an external image processor circuit (as an exemplary external circuit) are electrically connected to the camera module 3 via connectors. In this embodiment, the plurality of cables are fine-line coaxial cables of the same length, and the number of cables provided is forty. Those cables (forty cables) are grouped into four bundles of cables 11, each consisting of ten cables. Note that the number of the cables provided (e.g., forty) is only an example and should not be construed as limiting.

The actuator 2 includes an upper ring 4, a movable unit 10, a fixed unit 20, a driving unit 30, a stopper member 80, a first printed circuit board 90, and a second printed circuit board 91 as shown in FIGS. 2A and 3.

The movable unit 10 includes a camera holder 40 and a movable base 41 (see FIG. 3). The movable unit 10 is fitted into the fixed unit 20 with some gap left between the movable unit 10 and the fixed unit 20. The movable unit 10 rotates (i.e., rolls) around the optical axis 1a of the lens of the camera module 3 with respect to the fixed unit 20. The movable unit 10 also rotates around an axis 1b and an axis 1c, both of which are perpendicular to the optical axis 1a, with respect to the fixed unit 20. In this case, the axis 1b and the axis 1c are both perpendicular to a fitting direction, in which the movable unit 10 is fitted into the fixed unit 20 while the movable unit 10 is not rotating. Furthermore, these axes 1b and 1c intersect with each other at right angles. A detailed configuration of the movable unit 10 will be described later. The camera module 3 has been mounted on the camera holder 40. The camera holder 40 includes a circular cylindrical columnar portion 401 protruding along the optical axis 1a of the camera module 3. The configuration of the movable base 41 will be described later. Rotating the movable unit 10 allows the camera module 3 to rotate. In this embodiment, when the optical axis 1a is perpendicular to both of the axes 1b and 1c, the movable unit 10 (i.e., the camera module 3) is defined to be in a neutral position. In the following description, the direction in which the movable unit 10 (camera module 3) rotates around the axis 1b is defined herein as a “tilting direction” and the direction in which the movable unit 10 (camera module 3) rotates around the axis 1c is defined herein as a “panning direction.” Furthermore, the direction in which the movable unit 10 (camera module 3) rotates (rolls) around the optical axis 1a is defined herein as a “rolling direction.”

The fixed unit 20 includes a coupling member 50 and a body 51 (see FIG. 3).

The coupling member 50 includes four coupling bars 50a extending from a center portion thereof. Each of the four coupling bars 50a is generally perpendicular to two adjacent coupling bars 50a. Also, each of the four coupling bars 50a is bent such that the tip portion thereof is located below the center portion. The coupling member 50 is screwed onto the body 51 with the movable base 41 interposed between itself and the body 51. Specifically, the respective tip portions of the four coupling bars 50a are screwed onto the body 51.

The fixed unit 20 includes a pair of first coil units 52 and a pair of second coil units 53 to make the movable unit 10 electromagnetically drivable and rotatable (see FIG. 3). The pair of first coil units 52 allows the movable unit 10 to rotate around the axis 1b, and the pair of second coil units 53 allows the movable unit 10 to rotate around the axis 1c.

The pair of first coil units 52 each include a first magnetic yoke 710 made of a magnetic material, drive coils 720 and 730, and magnetic yoke holders 740 and 750 (see FIG. 3). Each of the first magnetic yokes 710 has the shape of an arc, of which the center is defined by the center 510 of rotation (see FIG. 2B). The pair of drive coils 730 are each formed by winding a conductive wire around its associated first magnetic yoke 710, of which the winding direction is defined around the axis 1b, such that the pair of first driving magnets 620 (to be described later) are driven in rotation in the rolling direction. After each drive coil 730 has been formed around its associated first magnetic yoke 710, the magnetic yoke holders 740 and 750 are secured with screws onto the first magnetic yoke 710 on both sides of the magnetic yoke 710 along the axis 1b. Thereafter, the drive coils 720 are each formed by winding a conductive wire around its associated first magnetic yoke 710 such that its winding direction is defined around the optical axis 1a when the movable unit 10 is in the neutral position and that the pair of first driving magnets 620 are driven in rotation in the tilting direction. Then, the pair of first coil units 52 are secured with screws onto the upper ring 4 and the body 51 so as to face each other along the axis 1c when viewed from the camera module 3 (see FIGS. 2A and 3). Note that in this embodiment, the winding direction of the coil is a direction in which the number of coil turns increases (e.g., in the axial direction in the case of a cylindrical coil).

The pair of second coil units 53 each include a second magnetic yoke 711 made of a magnetic material, drive coils 721 and 731, and magnetic yoke holders 741 and 751 (see FIG. 3). Each of the second magnetic yokes 711 has the shape of an arc, of which the center is defined by the center 510 of rotation (see FIG. 2B). The pair of drive coils 731 are each formed by winding a conductive wire around its associated second magnetic yoke 711, of which the winding direction is defined around the axis 1c, such that the pair of second driving magnets 621 (to be described later) are driven in rotation in the rolling direction. After each drive coil 731 has been formed around its associated second magnetic yoke 711, the magnetic yoke holders 741 and 751 are secured with screws onto the second magnetic yoke 711 on both sides of the magnetic yoke 71 along the axis 1c. Thereafter, the drive coils 721 are each formed by winding a conductive wire around its associated second magnetic yoke 711 such that its winding direction is defined around the optical axis 1a when the movable unit 10 is in the neutral position and that the pair of second driving magnets 621 are driven in rotation in the panning direction. Then, the pair of second coil units 53 are secured with screws onto the upper ring 4 and the body 51 so as to face each other along the axis 1b when viewed from the camera module 3 (see FIGS. 2A and 3).

The camera module 3 that has been mounted on the camera holder 40 is fixed onto the movable unit 10 with the coupling member 50 interposed between itself and the movable base 41. The upper ring 4 is secured with screws onto the body 51 to sandwich the camera module 3, fixed onto the movable unit 10, between itself and the body 51 (see FIG. 3).

The stopper member 80 is a non-magnetic member. To prevent the movable unit 10 from falling off, the stopper member 80 is secured with screws onto the other side, opposite from the side to which the coupling member 50 is secured, of the body 51, so as to close an opening 706 of the body 51.

The first printed circuit board 90 includes a plurality of (e.g., four) magnetic sensors 92 for detecting rotational positions in the tilting and panning directions of the camera module 3. In this embodiment, the magnetic sensors 92 may be implemented as Hall elements, for example. On the first printed circuit board 90, further assembled is a circuit for controlling the amount of a current allowed to flow through the drive coils 720, 721, 730, and 731 (such as a circuit having the function of the driver unit 120 shown in FIG. 1).

On the second printed circuit board 91, assembled are a microcomputer (micro controller) 93 and other components (see FIGS. 2B and 3). The microcomputer 93 performs the functions of the control unit 110 shown in FIG. 1 by executing a program stored in a memory. In this embodiment, the program is stored in advance in the memory of the computer. Alternatively, the program may also be downloaded via a telecommunications line such as the Internet or distributed after having been stored on a storage medium such as a memory card. The control unit 110 will be described in detail later.

Next, a detailed configuration for the movable base 41 will be described.

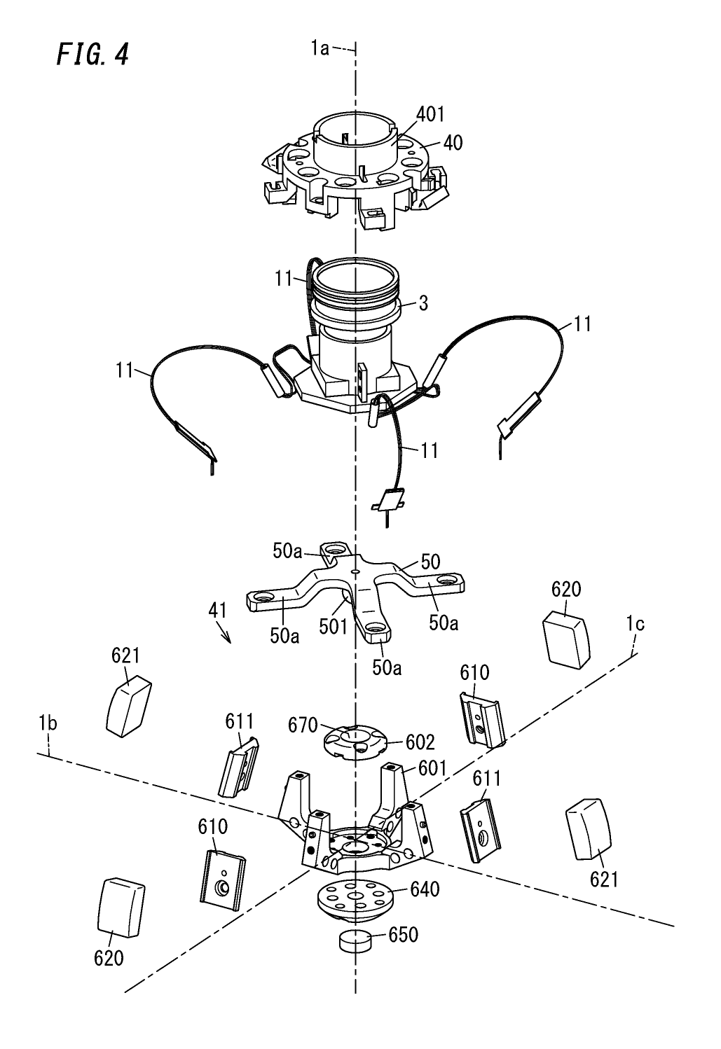

The movable base 41 has a loosely fitting space, and supports the camera module 3 thereon. The movable base 41 includes a body 601, a first loosely fitting member 602, a pair of first magnetic back yokes 610, a pair of second magnetic back yokes 611, a pair of first driving magnets 620, and a pair of second driving magnets 621 (see FIG. 4). The movable base 41 further includes a bottom plate 640 and a position detecting magnet 650 (see FIG. 4).

The body 601 includes a disk portion and four fixing portions (arms) protruding from the outer periphery of the disk portion toward the camera module 3 (i.e., upward). Two of the four fixing portions face each other along the axis 1b, and the other two fixing portions face each other along the axis 1c. Each of the four fixing portions has a generally L-shape, and will be hereinafter referred to as an “L-shaped fixing portion.” Each of these four L-shaped fixing portions faces, one to one, an associated one of the pair of first coil units 52 or an associated one of the pair of second coil units 53. The camera holder 40 is secured with screws to respective tips of the upper portions of the L-shaped fixing portions. This allows the camera holder 40 to be supported by the movable base 41.

The first loosely fitting member 602 has a through hole in a tapered shape. The first loosely fitting member 602 has, as a first loosely fitting face 670, an inner peripheral face of the through hole in the tapered shape (see FIG. 4). The first loosely fitting member 602 is secured with screws onto the disk portion of the body 601 such that the first loosely fitting face 670 is exposed to the loosely fitting space.

The pair of first magnetic back yokes 610 are each provided one to one for an associated one of two, facing the pair of first coil units 52, out of the four L-shaped fixing portions. The pair of first magnetic back yokes 610 are secured with a pair of screws onto the two L-shaped fixing portions facing the pair of first coil units 52. The pair of second magnetic back yokes 611 are each provided one to one for an associated one of two, facing the pair of second coil units 53, out of the four L-shaped fixing portions. The pair of second magnetic back yokes 611 are secured with a pair of screws onto the two L-shaped fixing portions facing the pair of second coil units 53.

The pair of first driving magnets 620 are each provided one to one for an associated one of the pair of first magnetic back yokes 610. The pair of second driving magnets 621 are each provided one to one for an associated one of the pair of second magnetic back yokes 611. This allows the pair of first driving magnets 620 to face the pair of first coil units 52, and also allows the pair of second driving magnets 621 to face the pair of second coil units 53.

The bottom plate 640 is a non-magnetic member and may be made of brass, for example. The bottom plate 640 is provided for the other side, opposite from the side with the first loosely fitting member 602, of the body 601 to define the bottom of the movable unit 10 (i.e., the bottom of the movable base 41). The bottom plate 640 is secured with screws onto the body 601. The bottom plate 640 serves as a counterweight. Having the bottom plate 640 serve as a counterweight allows the center 510 of rotation to agree with the center of gravity of the movable unit 10. That is why when external force is applied to the entire movable unit 10, the moment of rotation of the movable unit 10 around the axis 1b and the moment of rotation of the movable unit 10 around the axis 1c both decrease. This allows the movable unit 10 (or the camera module 3) to be held in the neutral position, or to rotate around the axes 1b and 1c, with less driving force, thus reducing the power consumption of the camera device 1.

The position detecting magnet 650 is provided for a center portion of an exposed surface of the bottom plate 640.

As the movable unit 10 rotates, the position detecting magnet 650 changes its position, thus causing a variation in the magnetic force applied to the four magnetic sensors 92 provided for the first printed circuit board 90. The four magnetic sensors 92 detect a variation, caused by the rotation of the position detecting magnet 650, in the magnetic force, and calculate two-dimensional angles of rotation with respect to the axes 1b and 1c. This allows the four magnetic sensors 92 to detect respective rotational positions in the tilting and panning directions. In addition, the camera device 1 further includes, separately from the four magnetic sensors 92, another magnetic sensor for detecting the rotation of the movable unit 10 (i.e., the rotation of the camera unit 3) around the optical axis 1a. Note that the sensor for detecting the rotation around the optical axis 1a does not have to be a magnetic sensor but may also be a gyrosensor, for example.

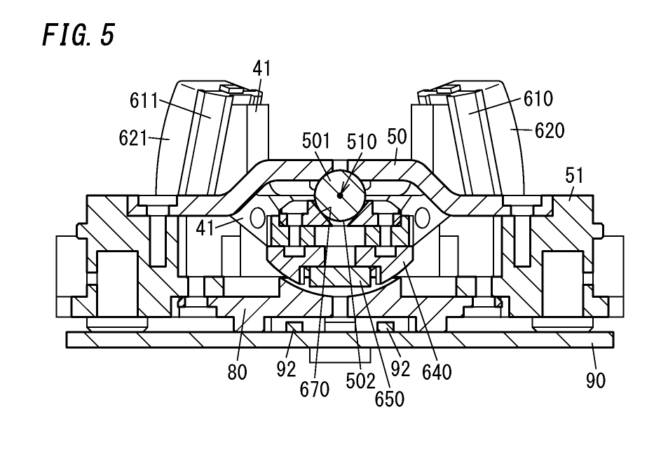

The coupling member 50 includes, at a center portion thereof (i.e., in a recess formed by respective bends of the four coupling bars), a second loosely fitting member 501 in a spherical shape (see FIGS. 2B and 4). The second loosely fitting member 501 has a second loosely fitting face 502 with a raised spherical surface (see FIG. 5). The spherical second loosely fitting member 501 is bonded with an adhesive onto the center portion (recess) of the coupling member 50.

The coupling member 50 and the first loosely fitting member 602 are joined together. Specifically, the first loosely fitting face 670 of the first loosely fitting member 602 is brought into point or line contact with, and fitted with a narrow gap left (i.e., loosely fitted) onto, the second loosely fitting face 502 of the second loosely fitting member 501. This allows the coupling member 50 to pivotally support the movable unit 10 so as to make the movable unit 10 freely rotatable. In this case, the center of the spherical second loosely fitting member 501 defines the center 510 of rotation.

The stopper member 80 has a recess, and is secured onto the body 51 such that a lower portion of the position detecting magnet 650 is introduced into the recess. A gap is left between the inner peripheral face of the recess of the stopper member 80 and the bottom of the bottom plate 640. The inner peripheral face of the recess of the stopper member 80 and the outer peripheral face of the bottom of the bottom plate 640 have curved faces that face each other. In this case, a gap is also left between the inner peripheral face of the recess of the stopper member 80 and the position detecting magnet 650. This gap is wide enough, even when the bottom plate 640 or the position detecting magnet 650 comes into contact with the stopper member 80, for the first driving magnets 620 and the second driving magnets 621 to return to their home positions due to their magnetism. This prevents, even when the camera module 3 is pressed toward the first printed circuit board 90, the camera module 3 from falling off, and also allows the pair of first driving magnets 620 and the pair of second driving magnets 621 to return to their home positions.

Note that the position detecting magnet 650 is suitably arranged inside of the outer periphery of the bottom of the bottom plate 640.

In this case, the pair of first driving magnets 620 serves as attracting magnets, thus producing first magnetic attraction forces between the pair of first driving magnets 620 and the first magnetic yokes 710 that face the first driving magnets 620. Likewise, the pair of second driving magnets 621 also serves as attracting magnets, thus producing second magnetic attraction forces between the pair of second driving magnets 621 and the second magnetic yokes 711 that face the second driving magnets 621. The vector direction of each of the first magnetic attraction forces is parallel to a centerline that connects together the center 510 of rotation, the center of mass of an associated one of the first magnetic yokes 710, and the center of mass of an associated one of the first driving magnets 620. The vector direction of each of the second magnetic attraction forces is parallel to a centerline that connects together the center 510 of rotation, the center of mass of an associated one of the second magnetic yokes 711, and the center of mass of an associated one of the second driving magnets 621.

The first and second magnetic attraction forces become normal forces produced by the second loosely fitting member 501 of the fixed unit 20 with respect to the first loosely fitting member 602. Also, when the movable unit 10 is in the neutral position, the magnetic attraction forces of the movable unit 10 define a synthetic vector along the optical axis 1a. This force balance between the first magnetic attraction forces, the second magnetic attraction forces, and the synthetic vector resembles the dynamic configuration of a balancing toy, and allows the movable unit 10 to rotate in three axis directions with good stability.

In this embodiment, the pair of first coil units 52, pair of second coil units 53, pair of first driving magnets 620, and pair of second driving magnets 621 described above together form the driving unit 30 (see FIG. 1). The driving unit 30 includes a first driving unit 30a, a second driving unit 30b, and a third driving unit 30c as shown in FIG. 1. The first driving unit 30a rotates the movable unit 10 in the tilting direction. The second driving unit 30b rotates the movable unit 10 in the panning direction. The third driving unit 30c rotates the movable unit 10 in the rolling direction.

The first driving unit 30a includes the pair of first magnetic yokes 710 and pair of drive coils 720 (first drive coils) included in the pair of first coil units 52, and the pair of first driving magnets 620. The second driving unit 30b includes the pair of second magnetic yokes 711 and pair of drive coils 721 (second drive coils) included in the pair of second coil units 53, and the pair of second driving magnets 621. The third driving unit 30c includes the pair of first driving magnets 620, the pair of second driving magnets 621, the pair of first magnetic yokes 710, the pair of second magnetic yokes 711, the pair of drive coils 730 (third drive coils), and the pair of drive coils 731 (fourth drive coils).

The camera device 1 of this embodiment allows the movable unit 10 to rotate two-dimensionally (i.e., pan and tilt) by supplying electricity to the pair of drive coils 720 and the pair of drive coils 721 simultaneously. In addition, the camera device 1 also allows the movable unit 10 to rotate (i.e., to roll) around the optical axis 1a by supplying electricity to the pair of drive coils 730 and the pair of drive coils 731 simultaneously.

Next, a functional configuration of the actuator 2 will be described.

The actuator 2 includes a storage unit 100, a control unit 110, a driver unit 120, and a driving unit 30 (see FIG. 1).

The storage unit 100 is implemented as a device selected from the group consisting of a read-only memory (ROM), a random access memory (RAM), an electrically erasable programmable read-only memory (EEPROM), and other storage devices. The storage unit 100 stores acoustic information. As used herein, the “acoustic information” refers to information including acoustic data that forms the basis of an audible sound to be emitted by driving the movable unit 10 in vibration in the rolling direction. In this embodiment, the acoustic information is language information including audio data representing a speech uttered by a human speaker as the acoustic data. As used herein, “to drive something in vibration” means vibrating an object to be driven (such as the movable unit 10 or the camera module 3) in a predetermined direction (such as the rolling direction).

The control unit 110 has the capability of controlling the rotational drive of the movable unit 10. The function of the control unit 110 is performed by the microcomputer 93 executing a program as described above. The control unit 110 includes a processing unit 111, a first generating unit 112, and a second generating unit 113 as shown in FIG. 1.

The processing unit 111 outputs drive signals for driving the movable unit 10 in rotation in the tilting, panning, and rolling directions, respectively, to the driver unit 120. The processing unit 111 instructs, while making an operation check during startup, the first generating unit 112 to generate an acoustic drive signal and the second generating unit 113 to generate a first drive signal and a second drive signal. After having made the operation check, the processing unit 111 instructs the second generating unit 113 to generate the first and second drive signals and a third drive signal. The processing unit 111 sorts out the destinations of the respective drive signals generated by the first generating unit 112 and the second generating unit 113. The processing unit 111 outputs the first and second drive signals, generated by the second generating unit 113, to a first driver unit 121 and a second driver unit 122 (to be described later), respectively. The processing unit 111 also outputs either the acoustic drive signal generated by the first generating unit 112 or the third drive signal generated by the second generating unit 113 to a third driver unit 123 (to be described later). As used herein, the “acoustic drive signal” refers to a drive signal for driving the movable unit 10 in vibration in the rolling direction. The “first drive signal” refers herein to a drive signal for driving the movable unit 10 in rotation in the tilting direction. The “second drive signal” refers herein to a drive signal for driving the movable unit 10 in rotation in the panning direction. The “third drive signal” refers herein to a drive signal for driving the movable unit 10 in rotation in the rolling direction.

The first generating unit 112 generates, on receiving an instruction to generate an acoustic drive signal from the processing unit 111, the acoustic drive signal based on acoustic information. Specifically, the first generating unit 112 generates, by a pulse width modulation (PWM) method for changing the on-duty ratio on a cycle basis, an acoustic drive signal based on acoustic data (audio data) included in the acoustic information stored in the storage unit 100. The first generating unit 112 outputs the acoustic drive signal thus generated to the processing unit 111. In this embodiment, the acoustic drive signal generated by the first generating unit 112 has an audible sound frequency, which may fall within the range of 1 kHz to 8 kHz, for example.

The second generating unit 113 generates the first drive signal, second drive signal, and third drive signals described above and outputs these drive signals generated to the processing unit 111. In this embodiment, the frequencies of the respective drive signals generated by the second generating unit 113 are determined to allow the actuator 2 to function as a stabilizer 2a and may fall within the range of a few ten Hz to several ten Hz. To allow the actuator 2 to serve as a stabilizer 2a, the drive signals suitably have a frequency of 40-50 Hz or less. That is to say, the frequency of the acoustic drive signal (audible sound frequency) is higher than that of the drive signals.

The driver unit 120 includes the first driver unit 121, the second driver unit 122, and the third driver unit 123. The first driver unit 121 controls output of the first drive signal to the first driving unit 30a. The second driver unit 122 controls output of the second drive signal to the second driving unit 30b. The third driver unit 123 controls output of the acoustic drive signal and the third drive signal to the third driving unit 30c.

This configuration allows the control unit 110 to output the acoustic drive signal to the third driving unit 30c via the third driver unit 123. A current, of which the amount is controlled by the acoustic drive signal, flows through the pair of drive coils 730 and pair of drive coils 731 of the third driving unit 30c. Applying the voltage of the acoustic drive signal to the respective drive coils 730 and 731 allows the movable unit 10 to be driven in vibration in the rolling direction in resonance with the frequency of the acoustic drive signal. This vibration produces an audible sound. Also, the greater the duty of the PWM is, the larger the amplitude of vibration of the movable unit 10 becomes. That is why the duty is suitably increased with an increase in the amplitude of the acoustic drive signal.

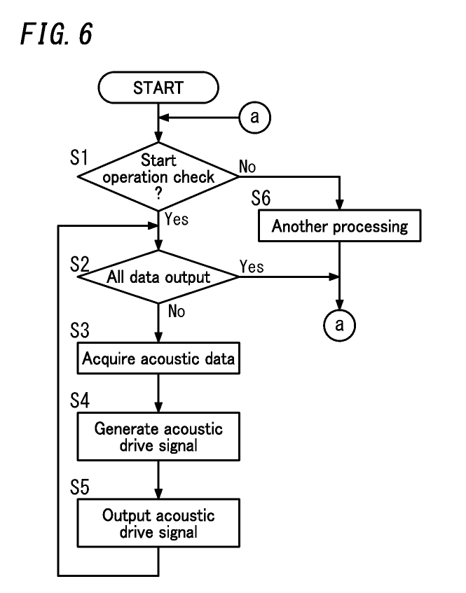

Next, it will be described with reference to the flowchart of FIG. 6 how to make an operation check (such as the operation check of a rotational drive in the rolling direction, among other things) after the startup processing to be performed when the camera device 1 is powered.

First, the processing unit 111 of the control unit 110 decides whether or not an operation check should be started (in Step S1). Specifically, the processing unit 111 determines, when the camera device 1 is started, whether or not all circuits required to allow the device 1 to function as a camera have been activated (i.e., whether or not the startup processing has been done).

When a determination is made that the operation check should be started (if the answer is YES in Step S1), the processing unit 111 instructs the first generating unit 112 to generate an acoustic drive signal. The first generating unit 112 determines, on receiving the instruction to generate the acoustic drive signal, whether or not all of the acoustic data (audio data) included in the acoustic information has been output (in Step S2).

On the other hand, when a determination is made that not all of the acoustic data should have been output yet (if the answer is NO in Step S2), the first generating unit 112 acquires the acoustic data included in the acoustic information from the storage unit 100 (in Step S3). Then, the first generating unit 112 generates, based on the acoustic data thus acquired, an acoustic drive signal by the PWM method (in Step S4). The processing unit 111 outputs the acoustic drive signal, generated by the first generating unit 112, to the third driving unit 30c via the third driver unit 123 (in Step S5).

Meanwhile, when a determination is made that the operation check should not be started (if the answer is NO in Step S1), the camera device 1 performs another type of processing (in Step S6).

When a determination is made that all of the acoustic data has already been output (if the answer is YES in Step S2), the process goes back to Step S1.

This processing allows a current, of which the amount is controlled by the acoustic drive signal, to flow through the pair of drive coils 730 and pair of drive coils 731 in the third driving unit 30c. This allows the movable unit 10 to be driven in vibration to produce an audible sound. Therefore, when starting the camera device 1, the user is allowed to check the drive in the rolling direction by an audible sound, not by eye inspection.

Note that during the operation check, the processing unit 111 outputs the first drive signal, generated by the second generating unit 113, to the first driving unit 30a via the first driver unit 121 and also outputs the second drive signal to the second driving unit 30b via the second driver unit 122 while performing the operation described above. This allows the user to check the rotational drive operations in the tilting and panning directions. In addition, producing the audible sound after the startup processing notifies the user of the camera device 1 that the startup processing has been finished.

Optionally, the processing unit 111 may perform the rotational drive in at least one of the tilting and panning directions while checking the startup. This allows the rotational drive to be performed in at least one of the tilting and panning directions while driving the movable unit 10 in rotation in the rolling direction during the startup check (i.e., while producing an audible sound).

(Variations)

Next, variations will be enumerated one after another. Note that any of the variations to be described below may be combined with any of the embodiments described above as appropriate.

In the embodiment described above, the audible sound is produced while the movable unit 10 is being driven in vibration in the rolling direction. However, this is only an example and should not be construed as limiting. Alternatively, the audible sound may also be produced while the movable unit 10 is being driven in vibration in either the tilting direction or the panning direction. Still alternatively, the audible sound may also be produced while the movable unit 10 is being driven in vibration in a plurality of directions. That is to say, the actuator 2 may be configured to produce the audible sound while driving the movable unit 10 in vibration in at least one of the tilting, panning, and rolling directions.

For example, when producing the audible sound by driving the movable unit 10 in vibration in a plurality of directions, the actuator 2 may produce, in accordance with the acoustic information, the audible sound while rotating the movable unit 10 in the rolling direction and while rotating the movable unit 10 in the tilting direction, respectively. Alternatively, the actuator 2 may also produce, in accordance with the acoustic information, the audible sound while rotating the movable unit 10 in the rolling direction and while rotating the movable unit 10 in the panning direction, respectively. Still alternatively, the actuator 2 may also produce, in accordance with the acoustic information, the audible sound while rotating the movable unit 10 in the tilting direction and while rotating the movable unit 10 in the panning direction, respectively. For example, the first generating unit 112 may generate a first acoustic drive signal, which is the acoustic drive signal described above, and a second acoustic drive signal for driving the movable unit 10 in rotation in the panning direction while producing the audible sound. This allows the control unit 110 to produce the audible sound in accordance with the first acoustic drive signal and the second acoustic drive signal while driving the movable unit 10 in rotation in the rolling and tilting directions, respectively.

Also, when producing the audible sound in a plurality of directions, the actuator 2 may produce different audible sounds in the respective directions by generating vibrations at multiple different frequencies in the respective directions.

Optionally, in outputting the acoustic drive signal, the control unit 110 may superpose the acoustic drive signal on any of the drive signals. For example, when outputting the acoustic drive signal to the third driving unit 30c via the third driver unit 123, the control unit 110 may superpose the acoustic drive signal on the third drive signal.

In the embodiment described above, audio data representing a speech uttered by a human speaker is used as the acoustic data. However, this is only an example and should not be construed as limiting. The acoustic data does not have to be such audio data but may also be data representing a different sound such as a beep or a melody. This allows the actuator 2 to produce a beep, a melody, or any other sound.

Also, in the embodiment described above, the movable unit 10 is configured to be rotatable in the three directions, namely, the tilting direction, the panning direction, and the rolling direction. However, this is only an example and should not be construed as limiting. The actuator 2 may be configured to rotate the movable unit 10 in at least two directions selected from the group consisting of the tilting direction, the panning direction, and rolling direction. In that case, the actuator 2 produces the audible sound by driving the movable unit 10 in vibration in at least one of the at least two directions.

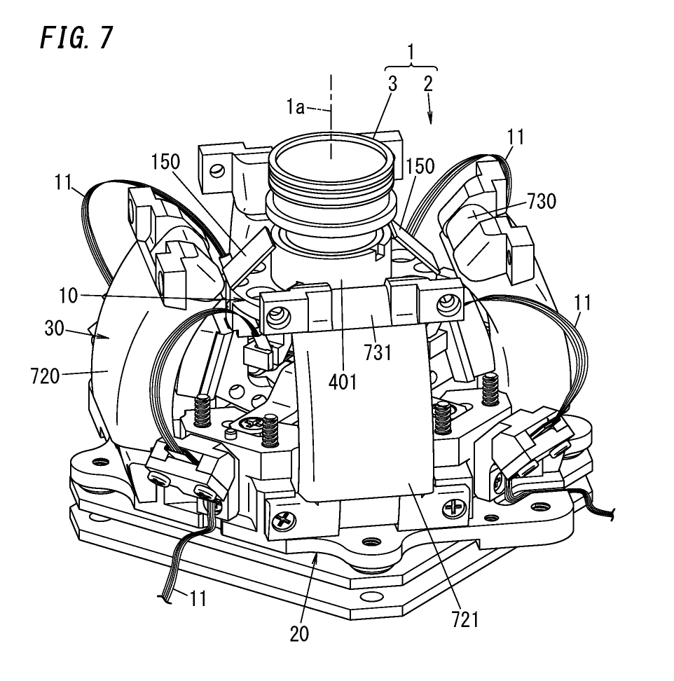

Optionally, in the embodiment described above, the actuator 2 may be configured to provide a vibration plate for at least one of the movable unit 10 or the fixed unit 20. FIG. 7 illustrates an alternative embodiment in which a plurality of vibration plates 150 are provided for the movable unit 10.

Each of these vibration plates 150 has one longitudinal end thereof fixed to the camera holder 40 of the movable unit 10 but does not have the other longitudinal end thereof fixed. Note that in FIG. 7, illustration of the upper ring 4 is omitted for convenience sake. Alternatively, a single vibration plate 150 may be provided either locally or entirely around the periphery of the columnar portion 401 of the movable unit 10. Providing the vibration plate 150 increases the area vibrating in response to the acoustic drive signal, thus increasing the loudness of the audible sound produced.

In the embodiment described above, the capability of emitting the audible sound is used to make an operation check when the drive is powered. However, this is only an example and should not be construed as limiting. Alternatively, the capability of emitting the audible sound may also be used to make an operation check during manufacturing, to provide voice guidance, or to make an error notification, for example.

Also, in the embodiment described above, the lens barrel 3c and the columnar portion 401 of the camera holder 40 have a circular cylindrical shape. However, this is only an example and should not be construed as limiting. Alternatively, the lens barrel 3c and the columnar portion 401 of the camera holder 40 may also be a rotor configured to turn around the optical axis 1a.

Furthermore, in the embodiment described above, the movable unit 10 and the fixed unit 20 are configured to be loosely fitted with each other by providing the spherical second loosely fitting member 501 between the coupling member 50 and the first loosely fitting member 602. However, this is only an example and should not be construed as limiting. Alternatively, the second loosely fitting member 501 may also be a partial sphere, of which the portion to be bonded with an adhesive to the coupling member 50 is a plane and of which a portion to be loosely fitted with the first loosely fitting member 602 has a curved surface. In that case, the portion with the curved surface of the partial sphere corresponds to the second loosely fitting face 502.

Furthermore, in the embodiment described above, the second loosely fitting member 501 is secured to the fixed unit 20, the movable unit 10 is provided with the first loosely fitting face 670, and the fixed unit 20 is provided with the second loosely fitting member 501 with the second loosely fitting face 502. However, this is only an example and should not be construed as limiting. Alternatively, the second loosely fitting member 501 may be secured to the first loosely fitting member 602 of the movable unit 10. In that case, the convex spherical surface of the second loosely fitting member 501 secured to the movable unit 10 corresponds to the second loosely fitting face and the center portion (recess) of the coupling member 50 of the fixed unit 20 corresponds to the first loosely fitting face.

Furthermore, in the embodiment described above, the actuator 2 is configured to produce, by the PWM method, an acoustic drive signal in accordance with the acoustic information. However, this is only an example and should not be construed as limiting. Alternatively, any other method may also be adopted as long as the acoustic drive signal may be generated, by the method adopted, in accordance with the acoustic information.

Furthermore, in the embodiment described above, the actuator 2 is configured to be applied to the camera device 1. However, this is only an example and should not be construed as limiting. Alternatively, the actuator 2 may be applied to a laser pointer, a haptic device, or any other type of device as well. For example, when the actuator 2 is applied to a laser pointer, a module for emitting a laser beam is provided for the movable unit 10. On the other hand, when the actuator 2 is applied to a haptic device, a lever is provided for the movable unit 10.

(Resume)

As can be seen from the foregoing description, an actuator (2) according to a first aspect includes: a movable unit (10) for holding an object to be driven (such as a camera module 3) thereon; a fixed unit (20); a driving unit (30): and a control unit (110). The fixed unit (20) holds the movable unit (10) so as to allow the movable unit (10) to rotate in at least two directions selected from the group consisting of a panning direction, a tilting direction, and a rolling direction. The driving unit (30) drives the movable unit (10) in rotation in the at least two directions with respect to the fixed unit (20). The control unit (110) outputs, to the driving unit (30), a drive signal for driving the movable unit (10) in rotation. The control unit (110) drives the movable unit (10) in vibration at a frequency of an audible sound in at least one direction out of the at least two directions.

This configuration allows an audible sound to be produced because the actuator (2) drives the movable unit (10) in vibration at a frequency of an audible sound in at least one direction in which the movable unit (10) is rotatable. This allows the user to check the drivability by a method other than eye inspection.

In an actuator (2) according to a second aspect, which may be implemented in conjunction with the first aspect, one of the at least two directions is the rolling direction. The control unit (110) drives the movable unit (10) in vibration in the rolling direction at the frequency of the audible sound in accordance with acoustic information about the audible sound. According to this configuration, the actuator (2) allows the user to check the drivability in the rolling direction by a method other than eye inspection.

An actuator (2) according to a third aspect, which may be implemented in conjunction with the first or second aspect, is used as a stabilizer (2a) to drive the movable unit (10) in a predetermined rotational direction. The control unit (110) outputs, to the driving unit (30), a drive signal for driving the movable unit (10) in rotation. This configuration allows the actuator (2) to reduce unnecessary vibrations of the object to be driven (such as a camera module 3) in driving the movable unit (10) in rotation.

In an actuator (2) according to a fourth aspect, which may be implemented in conjunction with the third aspect, the frequency of the audible sound is higher than a frequency of the drive signal. This configuration allows for sorting out the drive signal from a signal producing an audible sound (acoustic drive signal).

In an actuator (2) according to a fifth aspect, which may be implemented in conjunction with the third or fourth aspect, the control unit (110) drives the movable unit (10) in vibration in the rolling direction at the frequency of the audible sound. The control unit (110) drives the movable unit (10) in rotation with the drive signal in at least one of the panning direction or the tilting direction. This configuration allows the actuator (2) to drive the movable unit (10) in vibration in the rolling direction to produce an audible sound, while driving the movable unit (10) in rotation in another direction.

In an actuator (2) according to a sixth aspect, which may be implemented in conjunction with the second aspect, the acoustic information is language information including audio data representing a speech uttered by a human speaker. This configuration allows the actuator (2) to produce a speech by driving the movable unit (10) in vibration.

In an actuator (2) according to a seventh aspect, which may be implemented in conjunction with any one of the first to sixth aspects, the control unit (110) drives, when started, the movable unit (10) in vibration at the frequency of the audible sound. This configuration allows the user to check the drivability with an audible sound when the actuator (2) is started.

In an actuator (2) according to an eighth aspect, which may be implemented in conjunction with any one of the first to seventh aspects, the movable unit (10) includes: a holder (camera holder 40) to hold the object to be driven thereon; and a body (movable base 41) to support the holder. The holder includes a columnar portion (401) protruding in an axial direction, defining a center of the rolling direction, and serving as a rotor to rotate around the axial direction. This configuration allows the actuator (2) to drive the object to be driven in rotation with reliability.

An actuator (2) according to a ninth aspect, which may be implemented in conjunction with any one of the first to eighth aspects, further includes a vibration plate (150) to vibrate as the movable unit (10) is driven in vibration. This configuration increases the vibration area, and therefore, allows the actuator (2) to produce a louder audible sound.

In an actuator (2) according to a tenth aspect, which may be implemented in conjunction with any one of the first to ninth aspects, one of the fixed unit (20) or the movable unit (10) has a loosely fitting face (e.g., a first loosely fitting face 670). The other of the fixed unit (20) or the movable unit (10) includes a loosely fitting member (e.g., a second loosely fitting member 501) implemented as either a sphere or a portion of a partial sphere. The loosely fitting face is loosely fitted with the loosely fitting member. The movable unit (10) is electromagnetically driven in rotation with respect to the fixed unit (20). This configuration allows the actuator (2) to drive the movable unit (10) in rotation in at least two directions out of the tilting, panning, and rolling directions.

An actuator (2) according to an eleventh aspect, which may be implemented in conjunction with any one of the first to tenth aspects, further includes a storage unit (100) to store acoustic information about the audible sound. The control unit (110) generates, in accordance with the acoustic information, an acoustic drive signal having the frequency of the audible sound, and outputs the acoustic drive signal to the driving unit (30) to drive the movable unit in vibration at the frequency of the audible sound. This configuration allows the actuator (2) to generate an acoustic drive signal in accordance with acoustic information stored in advance.

A camera device (1) according to a twelfth aspect includes the actuator (2) according to any one of the first to eleventh aspects, and a camera module (3) serving as the object to be driven. In a camera device (1) with this configuration, the actuator (2) produces an audible sound in at least one direction in which the movable unit (10) is rotatable. This allows the user of the camera device (1) to check the drivability by a method other than eye inspection.

1. An actuator comprising:
a member configured to hold an object to be driven thereon;
a fixed member configured to hold the member so as to allow the member to rotate in at least two directions including a rolling direction and a direction selected from the group consisting of a panning direction and a tilting direction;
a drive configured to drive the member in rotation in the at least two directions with respect to the fixed member; and
a controller configured to output, to the drive, a drive signal for driving the member in rotation,
the controller being configured to drive the member in vibration at a frequency of an audible sound in at least one direction out of the at least two directions,
the member including:
a holder configured to hold the object to be driven thereon; and
a body configured to support the holder,
the holder including a columnar portion, the columnar portion protruding in an axial direction that defines a center of the rolling direction and serving as a rotor configured to rotate around the axial direction.

2. The actuator of claim 1, wherein
the controller is configured to drive the member in vibration in the rolling direction at the frequency of the audible sound in accordance with acoustic information about the audible sound.

3. The actuator of claim 1, wherein
the actuator is used as a stabilizer configured to drive the member in a predetermined rotational direction, and
the controller is configured to output, to the drive, a drive signal for driving the member in rotation.

4. The actuator of claim 3, wherein
the frequency of the audible sound is higher than a frequency of the drive signal.

5. The actuator of claim 3, wherein
the controller is configured to:
drive the member in vibration in the rolling direction at the frequency of the audible sound; and
drive the member in rotation with the drive signal in at least one of the panning direction or the tilting direction.

6. The actuator of claim 2, wherein
the acoustic information is language information including audio data representing a speech uttered by a human speaker.

7. The actuator of claim 1, wherein
the controller is configured to, when started, drive the member in vibration at the frequency of the audible sound.

8. The actuator of claim 1, further comprising a vibration plate configured to vibrate as the member is driven in vibration.

9. The actuator of claim 1, wherein
one of the fixed member or the member has a loosely fitting face,
the other of the fixed member or the member includes a loosely fitting member implemented as either a sphere or a portion of a partial sphere,
the loosely fitting face is loosely fitted with the loosely fitting member, and
the member is electromagnetically driven in rotation with respect to the fixed member.

10. The actuator of claim 1, further comprising a storage configured to store acoustic information about the audible sound, wherein
the controller is configured to generate, in accordance with the acoustic information, an acoustic drive signal having the frequency of the audible sound, and output the acoustic drive signal to the drive to drive the member in vibration at the frequency of the audible sound.

11. A camera device comprising
the actuator of claim 1; and
a camera module serving as the object to be driven.
